(19) United States
(12) Patent Application Publication
(10) Pub. No.: US 2010/0189240 A1
(43) Pub. Date: Jul. 29, 2010

(54) Contacting a person outside of a teleconference without leaving the teleconference

(76) Inventors: Steven M. Miller, Cary, NC (US); Jana H. Jenkins, Raleigh, NC (US); Lloyd W. Allen, JR., Cary, NC (US)

Correspondence Address: MOORE & VAN ALLEN, PLLC For IBM, P.O. Box 13706, Research Triangle Park, NC, 27709, US

(21) Appl. No.: 12/360,189

(22) Filed: Jan. 27, 2009

(51) Int. Cl. H04M 3/42

(52) U.S. Cl. 379/202.01

(57) ABSTRACT

Contacting a person while conducting a call that may include initiating a teleconference call, receiving a message during the teleconference call from a first person who has joined the teleconference call directed to a second person that has not joined the teleconference call, forwarding the message to the second person during the teleconference call, receiving a reply message from the second person during the teleconference call, and forwarding the reply message to the first person during the teleconference call. A processing device that may establish a teleconference call between telephones, receive a message during the conference call from a first telephone that has joined the teleconference call destined for a second telephone that has not joined the teleconference call, deliver the message to the second telephone, receive a reply message from the second telephone, and forward the reply message to the first telephone during the conference call.

### RELATED APPLICATIONS

The present application is related to the following applications that each have the same inventors and assignee and where the serial number is not yet known: “Accessing Details of Teleconference Call Invitees”, Atty Docket 014682-000099; “Providing Multilevel Conference Call Participants”, Atty Docket 014682-000100; “Enhanced Announcement of Conference Call Participants”, Atty Docket 014682-000101; “Rules-Based Teleconferencing”, Atty Docket 014682-000103.

### BACKGROUND OF THE INVENTION

The present invention is related to teleconferencing, and more specifically to contacting a person outside of a teleconference without leaving the teleconference.

Group meetings are a common and important element of many businesses. Teleconference calls are efficient in that they allow multiple people to have a meeting and not be physically located in the same room. Sometimes when a person calls into a teleconference call meeting, they find that some or all of the invitees of the teleconference that they need to be present for a successful discussion during the teleconference have not joined the teleconference. The person may desire to communicate with one or more of the missing invitees to determine if they are going to come to the teleconference call meeting, or whether a decision should be made as to whether the teleconference call should proceed or be rescheduled. Currently, a person that has joined into a teleconference call would need to leave the teleconference call and use another method in order to contact a missing invitee.

### BRIEF SUMMARY OF THE INVENTION

According to one aspect of the present invention, a method for contacting a person while conducting a call may include initiating a teleconference call, receiving a message during the teleconference call from a first person who has joined the teleconference call directed to a second person that has not joined the teleconference call, forwarding the message to the second person during the teleconference call, receiving a reply message from the second person during the teleconference call, and forwarding the reply message to the first person during the teleconference call.

According to another aspect of the present invention, a processing device may include a network interface, at least one second interface, the at least one second interface configured to establish a connection between at least three telephones, and a controller, the controller being configured to establish a teleconference call between the at least three telephones, receive a message during the conference call from a first telephone of the at least three telephones destined for at least one second telephone that has not joined the teleconference call, deliver the message to the at least one second telephone, receive at least one reply message from the at least one second telephone, and forward the at least one reply message to the first telephone during the conference call.

According to a further aspect of the present invention, a computer program product comprising a computer useable medium having computer useable program code embodied therewith, the computer useable program code comprising computer useable program code configured to initiate a teleconference call, computer useable program code configured to receive a message during the teleconference call from a first person who has joined the teleconference call directed to a second person that has not joined the teleconference call, computer useable program code configured to forward the message to the second person during the teleconference call, computer useable program code configured to receive a reply message from the second person during the teleconference call, and computer useable program code configured to forward the reply message to the first person during the teleconference call.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flowchart of a process for contacting a person while conducting a teleconference call according to an exemplary embodiment of the present invention;

FIG. 2 is a flowchart of a process for contacting a person while conducting a teleconference call according to another exemplary embodiment of the present invention;

FIG. 3 is a process for receiving an inquiry from a person on a teleconference call according to an exemplary embodiment of the present invention; and

FIG. 4 is a diagram of a system for contacting a person while conducting a teleconference call according to an exemplary embodiment of the present invention.

### DETAILED DESCRIPTION OF THE INVENTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention provide a method by which an individual on a teleconference call may contact people missing from the teleconference call after the individual has joined the teleconference call. The individual on the teleconference call may contact the missing people by any of many methods such as, for example, using a text message, a short message service (SMS), instant messaging (IM), telephone, email, etc. For example, a first person and a second person may have joined a teleconference call waiting for a third person to join them. While joining in the teleconference call or after joining the teleconference call, the first person may initiate a message via text message to the third person asking whether the third person is going to join the teleconference call. The third person may respond that they will be there in a couple of minutes. The third person may send their response using many methods, e.g., a text message, instant messaging, SMS, voice, etc., to the first person. The first person may receive the instant message during the teleconference call. Further, according to embodiments of the present invention, the instant message from the third person may be a synthesized version of a voice response that has been received from the third person. Therefore, the third person may have received the text message, responded via a telephone call where the voice of the third person may be synthesized into a text message and sent to the first person. Conversely, according to embodiments of the present invention, a third person may respond via a text message and the text message synthesized into a voice message and played to the first person. Moreover, according to embodiments of the present invention, the message being played may be heard by only the first party, a subset of active participants in the conference, or all active conference participants.

According to embodiments of the present invention, an individual that has joined a teleconference call or is on hold for joining a teleconference call, may access an invitee list to select an individual that has been invited to a teleconference call in order to send them a message. Further, the person may send the same message to a group of invitees or persons that have not yet joined the teleconference call. In addition, according to embodiments of the present invention, invitees may preselect desired methods used to contact them such as, for example, SMS, IM, telephone, etc.

According to embodiments of the present invention, a conference bridge may receive messages from a person that has joined a teleconference call, or is on hold to join a teleconference call, and may forward the received message to the desired/selected recipient. The conference bridge may receive a reply from the recipient and forward this reply to the originator of the message while the originator is participating in the teleconference call or is on hold for joining the teleconference call. The conference bridge may receive a voice reply from the recipient, synthesize the voice reply into a text message, and forward the text message to the person that has joined the teleconference call or is on hold to join the teleconference call. Further, a person that has joined a teleconference call, or is on hold to join a teleconference call, may send a message to a group of individuals that have not joined the teleconference call where the conference bridge may then forward this message to each individual person of the group, receive replies from each person in the group, and forward the replies to the person in the teleconference call or on hold to join the teleconference call.

Moreover, symbols on a keypad such as, for example, “*”, “#”, etc. may be used by a person that has joined a teleconference call while on the teleconference call to send a signal to a conference bridge of a specific command that the person wants to initiate. The command may be any of many types of commands, for example, for the conference bridge to send a message to one or more persons that have not joined the teleconference call, a request for an invitee list, a request for a list of individuals that have currently joined the teleconference call, etc. Symbols may also be used during a conference call (or before joining a conference call) to initiate other communications with a conference bridge.

According to embodiments of the present invention, a conference bridge may have access to an invitee list, calendar entry or database entry that provides list of individuals or groups invited to a call. These entries may include phone numbers, email address, messaging names, or other profile information that could provide the means to lookup other contact information not provided through a directory, database or other information service. Users may specify preferred means of contact as well as alternate means that could be used as necessary by the described methods and system.

According to embodiments of the present invention, a phone interface may be used by a user to forward their reply message where information can be in an audio format to be presented to one or more parties that have joined to the call. Alternatively, the conference bridge may communicate in other means to the specific user, groups or all using text messaging, IM, etc. This may also include a graphical user interface or application program that may provide messaging interfaces and/or visualization of the conference call and the calling parties and/or invitees.

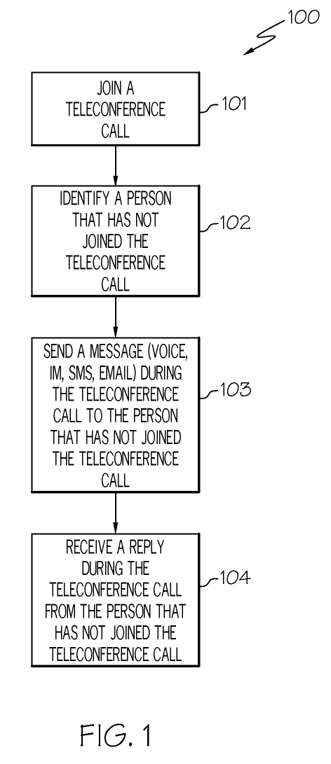

FIG. 1 shows a flowchart of a process for contacting a person while conducting a teleconference call according to an exemplary embodiment of the present invention. In the process 100, in block 101, a person may join a teleconference call. In block 102, a person that has not joined the teleconference call may be identified. In block 103, a message may be sent during the teleconference call to the person that has not joined the teleconference call. In block 104, a reply may be received during the teleconference call from the person who has not joined the teleconference call.

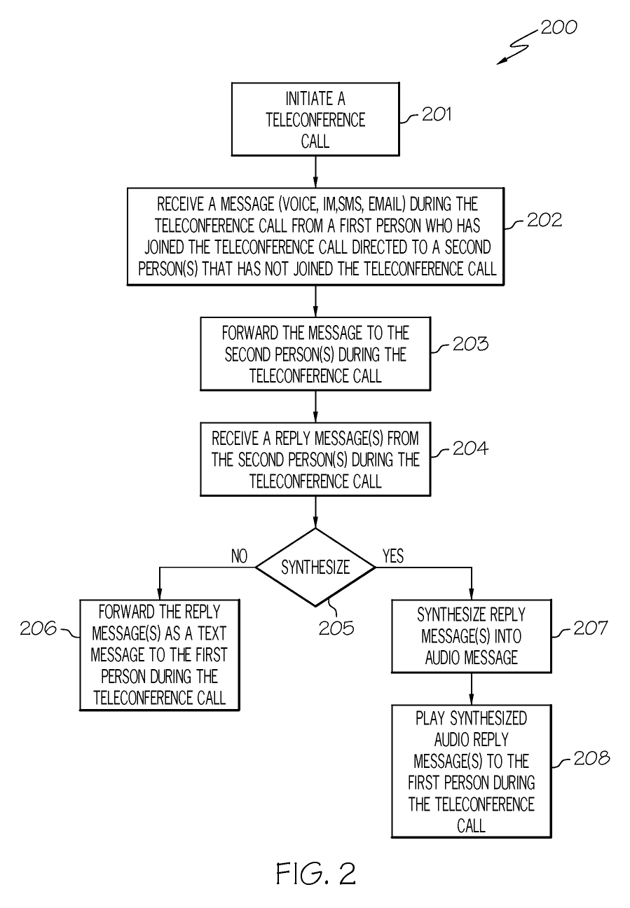

FIG. 2 shows a flowchart of a process for contacting a person while conducting a teleconference call according to another exemplary embodiment of the present invention. In the process 200, in block 201, a teleconference call may be initiated. In block 202, a message may be received during the teleconference call from a first person who has joined the teleconference call where the message may be directed to a second person that has not joined the teleconference call. In block 203, the message may be forwarded to the second person during the teleconference call. In block 204, a reply message may be received from the second person during the teleconference call. In block 205, it may be determined whether the reply message is a text message and whether it is desired to synthesize the text message, and if not, then in block 206, the reply message may be forwarded as a text message to the first person during the teleconference call. If the reply message is a text message and it is desired to synthesize the message, then in block 207, the reply message may be synthesized into an audio message. Then in block 208, the synthesized audio reply may be played to the first person during the teleconference call. Alternatively, according to embodiments of the present invention, an audio reply message may be received from the second person and the conference bridge may synthesize the audio reply message into a text message and send the synthesized text reply message to the first person during the teleconference call.

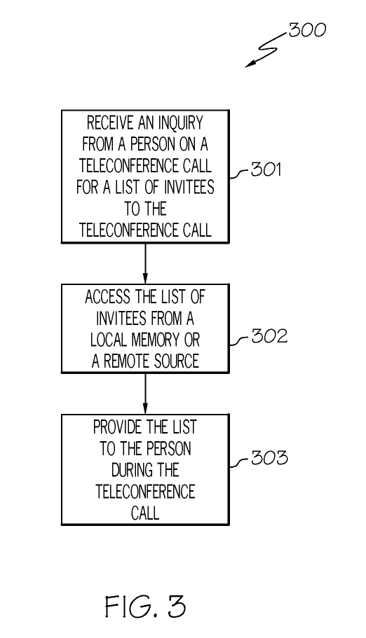

FIG. 3 shows a process for receiving an inquiry from a person on a teleconference call according to an exemplary embodiment of the present invention. In the process 300, in block 301, an inquiry may be received from a person on a teleconference call for a list of invitees to the teleconference call. In block 302, the list of invitees may be accessed from a local memory or a remote source. In block 303, the list of invitees may be provided to the person during the teleconference call.

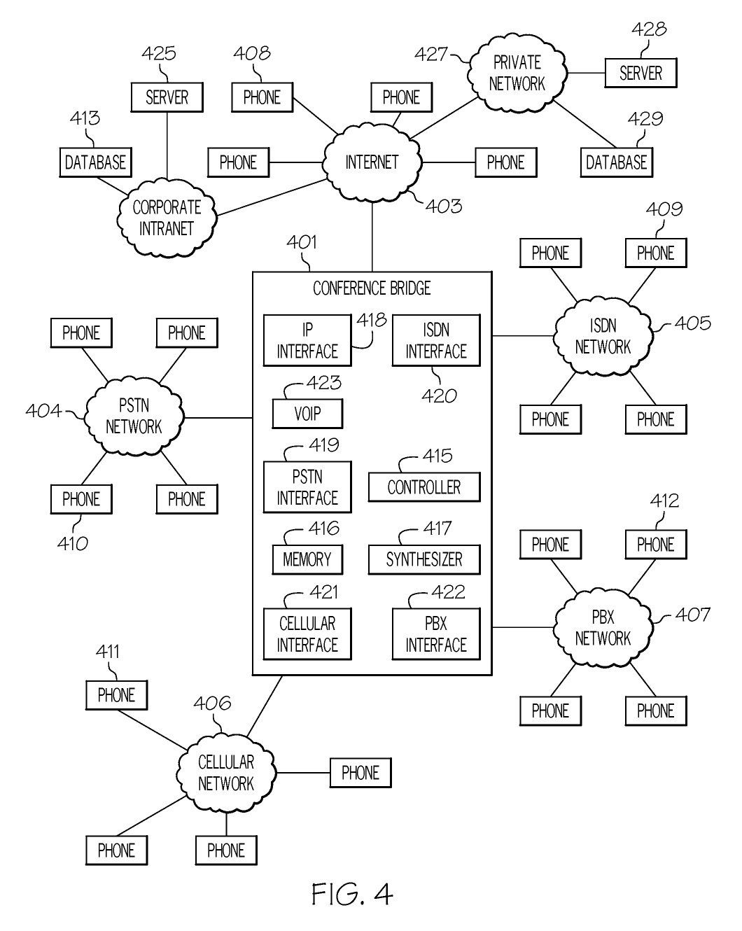

FIG. 4 shows a diagram of a system for contacting a person while conducting a teleconference call according to an exemplary embodiment of the present invention. The system 400 may include a teleconference bridge 401 that may be interconnected to one or more networks or other resources. For example, the conference bridge 401 may be interconnected to the Internet 403 that may be interconnected to one or more telephones 408, a corporate Intranet 402 that may have access to a database 413 and a server 425, a public switched telephone network (PSTN) 404 that may be connected to one or more telephones 410, a cellular network 406 that may be interconnected to one or more telephones 411, a Private Branch Exchange (PBX) network 407 that may be interconnected to one or more telephones 412, an Integrated Services Digital Network (ISDN) 405 that may be interconnected to one or more telephones 409, etc. The Internet 403 may also allow connection to a server 426, and a private network 427 that may be connected to a server 428 and a database 429.

The conference bridge 401 may setup a teleconference call with one or more telephones from any of the networks 402-407. Further, the teleconference bridge 401 may receive a message from one of the telephones that have joined the teleconference call and transfer the message to another telephone that has not joined the teleconference call while the teleconference call is occurring. The conference bridge 401 may forward a reply to the originator of the message. The conference bridge 401 may include an Internet Protocol (IP) interface 418, voice over IP (VOIP) processing 423, a PSTN interface 419, an ISDN interface 420, a cellular interface 421, a PDX interface 422, a synthesizer 417, memory 416, and a controller 415 that controls processing and all of the interfaces.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for contacting a person while conducting a call comprising:
initiating a teleconference call;
receiving a message during the teleconference call from a first person who has joined the teleconference call directed to a second person that has not joined the teleconference call;
forwarding the message to the second person during the teleconference call;
receiving a reply message from the second person during the teleconference call; and
forwarding the reply message to the first person during the teleconference call.

2. The method according to claim 1, further comprising receiving a text message from the first person during the teleconference call.

3. The method according to claim 1, further comprising receiving an instant messaging (IM) message from the first person during the teleconference call.

4. The method according to claim 1, further comprising receiving one of a text reply message from the second person and a voice reply message from the second person.

5. The method according to claim 4, further comprising synthesizing the text reply message to an audio message and forwarding the synthesized audio message to the first person when a text reply message is received from the second person and synthesizing the voice reply message to a text message and forwarding the synthesized text message to the first person when a voice reply message is received from the second person.

6. The method according to claim 1 further comprising providing an invitee list to the first person allowing identification of persons that have not joined the teleconference call.

7. The method according to claim 1, further comprising receiving a message for a group of persons that have not joined the teleconference call and forwarding the message for the group of persons to the group of persons during the teleconference call.

8. The method according to claim 7, further comprising receiving a reply message from at least one person of the group of persons during the teleconference call and forwarding the reply message from the at least one person of the group of persons to the first person during the teleconference call.

9. The method according to claim 1, further comprising forwarding the reply message during the teleconference call to all persons that have joined the conference call.

10. A processing device comprising:
a network interface;
at least one second interface, the at least one second interface configured to establish a connection between at least two telephones; and
a controller, the controller being configured to establish a teleconference call between the at least two telephones, receive a message during the conference call from a first telephone of the at least two telephones destined for at least one second telephone that has not joined the teleconference call, deliver the message to the at least one second telephone, receive at least one reply message from the at least one second telephone, and forward the at least one reply message to the first telephone during the conference call.

11. The processing device according to claim 10, wherein the processing device comprises a conference bridge.

12. The processing device according to claim 10, wherein the at least one second interface comprises a private branch exchange (PBX) interface.

13. The processing device according to claim 10, wherein the at least one second interface comprises a public switched telephone network (PSTN) interface.

14. The processing device according to claim 10, wherein the at least one second interface comprises a wireless telephone network interface.

15. The processing device according to claim 10, wherein the at least one second interface comprises an integrated services digital network (ISDN) interface.

16. A computer program product comprising a computer useable medium having computer useable program code embodied therewith, the computer useable program code comprising:
computer useable program code configured to initiate a teleconference call;
computer useable program code configured to receive a message during the teleconference call from a first person who has joined the teleconference call directed to a second person that has not joined the teleconference call;
computer useable program code configured to forward the message to the second person during the teleconference call;
computer useable program code configured to receive a reply message from the second person during the teleconference call; and
computer useable program code configured to forward the reply message to the first person during the teleconference call.

17. The computer program product according to claim 16, further comprising computer useable program code configured to receive a short message service (SMS) message from the first person during the teleconference call.

18. The computer program product according to claim 16, further comprising computer useable program code configured to receive an instant messaging (IM) message from the first person during the teleconference call.

19. The computer program product according to claim 16, further comprising computer useable program code configured to receive one of a text reply message from the second person and a voice reply message from the second person.

20. The computer program product according to claim 19, further comprising computer useable program code configured to synthesize the text reply message to an audio message and forward the synthesized audio message to the first person when a text reply message is received from the second person and computer useable program code configured to synthesize the voice reply message to a text message and forward the synthesized text message to the first person when a voice reply message is received from the second person.
